(19) United States
(12) Patent Application Publication
(10) Pub. No.: US 2012/0318256 A1
(43) Pub. Date: Dec. 20, 2012

(54) LARGE CAPACITY GRIDDLE OVER HIGH BTU BURNER

(75) Inventors: John Mark Chilton, Louisville, KY (US); Gonzalo Ocano, Louisville, KY (US); Michael Chezem, Louisville, KY (US); Cecil Clements, Louisville, KY (US); James Tomaszewski, Louisville, KY (US); Kyle Bradd, Louisville, KY (US); Wen Tao Zhuo, Louisville, KY (US)

(73) Assignee: General Electric Company

(21) Appl. No.: 13/161,778

(22) Filed: Jun. 16, 2011

(51) Int. Cl. F24C 15/10; A47J 37/10

(52) U.S. Cl. 126/39 H; 99/422

(57) ABSTRACT

A removable large and high capacity griddle for a stovetop for use in conjunction with one or more high BTU output burners. The griddle includes a number of features that allow for the large capacity griddle to be used on a gas range with high capacity burners including a flange extending from a bottom surface of the griddle for locating the griddle on an associated range, and for deflecting and/or otherwise channeling heat from one or more associated burners to regions of the griddle and deflecting heat from adjacent range structures, such as a rear control panel.

### BACKGROUND OF THE DISCLOSURE

This disclosure is related to removable griddles for use in connection with a gas cooking product. More particularly, the disclosure relates to a large capacity griddle for use on high output burners.

Removable griddles for stove cooktops have been available for use with conventional gas ranges. Traditional removable griddle designs have been relatively small in capacity (100 to 125 sq-in) and are generally used over burners with relatively low ratings (5K to 10K BTUs). Typical prior art griddles are generally used over one or two burners to promote even heating distributions but are generally smaller than desired. Larger style griddles have typically been constrained to permanent griddle designs where u-tube or other geometrically shaped burners can be used effectively to provide more even heating and control.

Past attempts to increase the size and capacity of removable griddles have heretofore been unsuccessful in achieving uniform heating and/or a griddle that can pass various performance and safety tests typically required of today's cooking appliances. Therefore, a consumer is presented with a choice: a smaller/lower capacity removable griddle; or a larger/higher capacity permanent griddle that permanently consumes stovetop space.

### SUMMARY OF THE DISCLOSURE

The present disclosure provides a removable larger/higher capacity griddle for a stovetop that overcomes the deficiencies of the prior art griddles noted above. The large capacity removable griddle can be used in conjunction with one or more high BTU output burners, and includes a number of features that allow for the large capacity griddle to be used on a gas range. These features include, among other things, a flange extending from a bottom surface of the griddle for locating the griddle on an associated range, and for deflecting and/or otherwise channeling heat from an associated burner to regions of the griddle and deflecting heat from adjacent range structures such as a rear control panel.

According to one aspect, a large capacity removable griddle for use in conjunction with one or more burners of an associated stove comprises a griddle body having an upper cooking surface and a lower surface adapted to face one or more burners of the associated stove, upwardly extending side walls surrounding at least a portion of the cooking surface, at least one flange extending downwardly from the lower surface of the griddle body, said flange surrounding at least a portion of at least two sides of the lower surface. The flange includes a plurality of recesses for receiving respective fingers of a burner support of the associated stove, the plurality of recesses being spaced apart along at least two sides of the flange such that when respective fingers are received at said recesses, the griddle is restricted from lateral and transverse movement in the plane of the cooking surface. The flange is adapted to channel heat towards a central portion of the griddle.

The at least one flange can further comprise both a front flange and a rear flange, each flange at least partially surrounding at least a portion of two sides of the burner when the griddle is installed thereon. The front and rear flanges can have a vertical dimension of between approximately 0.5″ and 2.5″ for spacing the lower surface of the griddle body from the one or more burners of the associated stove a desired amount. When the griddle is supported on the burner support, the flange is configured so as to not extend below the bottom of the fingers of the burner support. The griddle can include at least one gap between the front and rear flanges for venting heat from below the griddle body to an exterior of region. The at least one flange and the griddle body can be a unitary structure, such as may be formed via a casting process. In this regard, the griddle can be a monolithic structure made of cast iron.

At least one of the plurality of recesses and the at least one flange can have a shape corresponding to a profile of a burner finger of the associated stove. For example, the shape can include a semi-circular shape, or an oblong shape. The at least one flange can include a rear flange extending along a back edge and at least a portion to adjacent side edges of the lower surface of the griddle body. The rear flange can extend along one side edge and extends along the other side edge. A front flange can extend along a front edge of said lower surface. The griddle can include front and rear handles extending outwardly from the upwardly extending side walls located at front and rear edges of the griddle body. The front and rear handles can be formed integrally with the griddle body and the at least one flange. The side walls can extend relative to the upper cooking surface at an angle between about 45 and 90 degrees from vertical.

In accordance with another aspect, a stove comprising at least one burner, a burner support including a plurality of support fingers surrounding said burner, and a large capacity removable griddle as set forth above, at least partially supported on said burner support is provided. The at least one burner or burners can have a combined rating of at least 19,000 BTU's.

### BRIEF DESCRIPTION OF THE DRAWINGS

FIG. 1 is perspective view of a stove including a large capacity griddle in accordance with one exemplary embodiment.

FIG. 2 is a plan view of the large capacity griddle of FIG. 1.

FIG. 3 is a perspective view of a top side of an exemplary large capacity griddle.

FIG. 4 is a perspective view of a bottom side of an exemplary large capacity griddle.

FIG. 5 is a plan view of the griddle shown in FIGS. 3 and 4.

FIG. 6 is a cross-sectional view of the griddle taken along the line 6-6 in FIG. 5.

FIG. 7 is a cross-sectional view of the griddle shown in FIG. 5 taken along the line 7-7.

FIG. 8 is a cross-sectional view of the griddle shown in FIG. 5 taken along the line 8-8.

FIG. 9 is a perspective view of a stovetop and an exemplary griddle illustrating the support and locating points for securing the griddle to the stove.

FIG. 10 is a perspective view illustrating the support and locating points of a bottom surface of the griddle.

FIGS. 11 and 12 are perspective views of the griddle in position on the stovetop.

FIG. 13 is a perspective rear view of the griddle in position on the stovetop, with a portion of the stove removed for clarity.

FIG. 14 is another perspective view of the griddle in position on the stovetop.

### DETAILED DESCRIPTION OF THE PREFERRED EMBODIMENTS

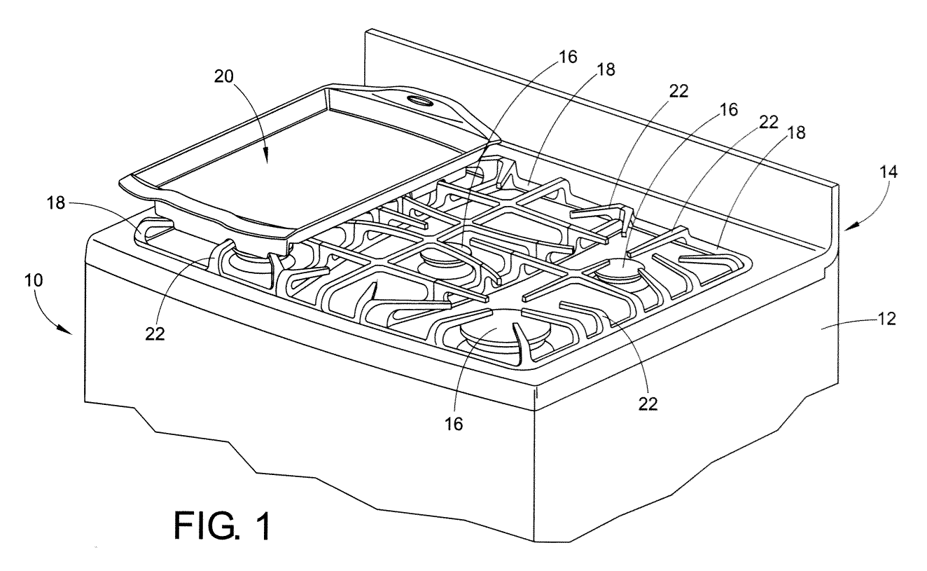

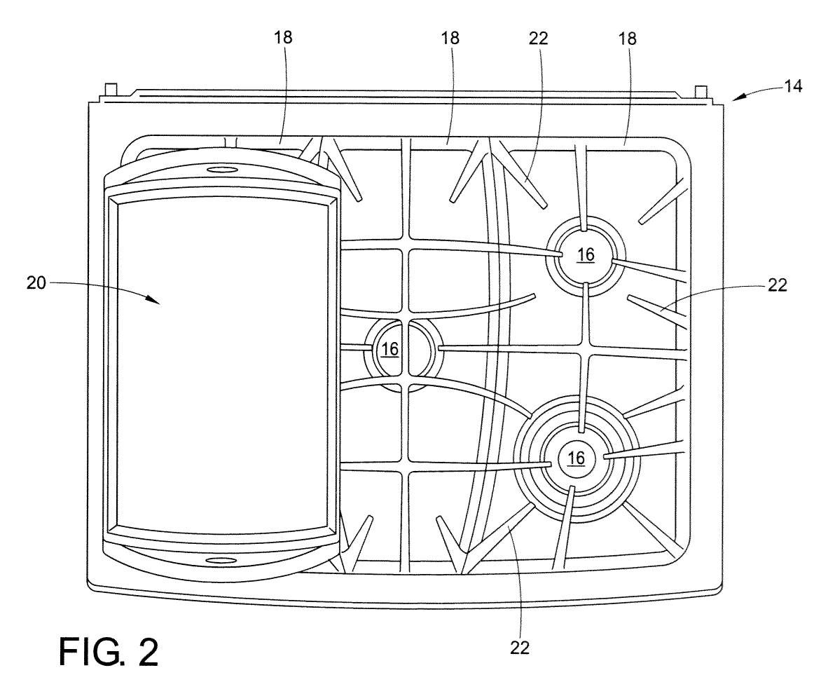

Turning now to the drawings and initially to FIGS. 1 and 2, an exemplary griddle in accordance with the disclosure is illustrated on top a stovetop. In the exemplary embodiment, the griddle 10 is supported over two burners (not shown) by burner supports that surround each burner. Each burner support has a plurality of fingers that are designed to support pots and pans as is conventional, as well as the exemplary griddle set forth in this disclosure.

The stove 10 generally includes a base portion 12 which can include an oven as is conventional, and the stovetop 14 that includes the plurality of burners 16. The burners 16 are each covered by burner supports 18 designed to support pots, pans, and as will be described in more detail below, the griddle 20. Each burner support includes a plurality of cantilevered fingers 22 that extend from a perimeter towards a central portion of a respective burner 16. The top surface of each finger 22 is generally aligned in a common plane to present a flat surface upon which to place pots, pans, etc. The fingers 22 cooperate with corresponding features on a bottom surface of the griddle 20 to interlock the griddle and restrict lateral movement relative to the stove 10.

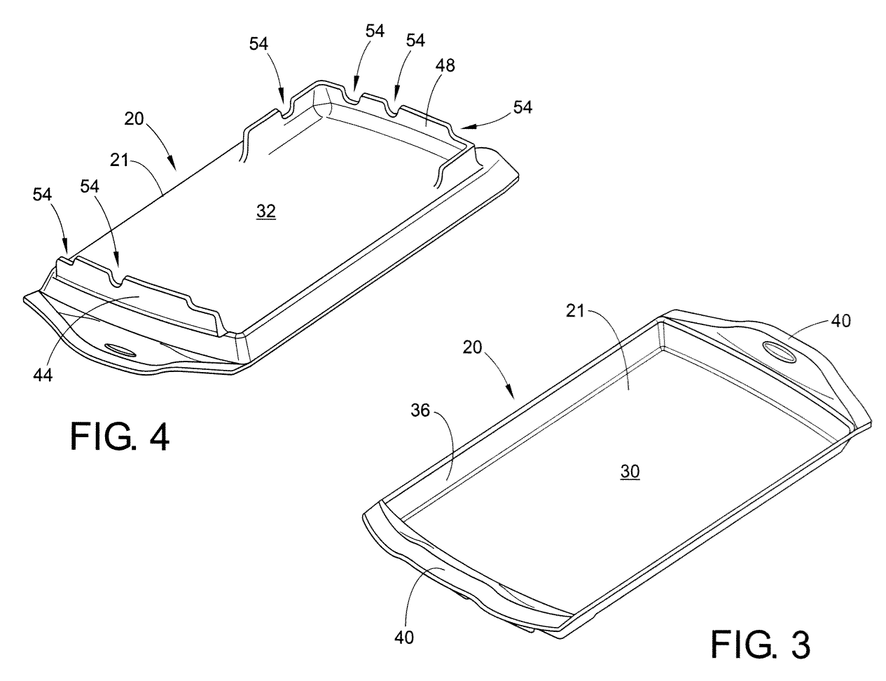

Turning to FIGS. 3 and 4, the griddle 20 generally comprises a griddle body 21 having an upper cooking surface 30 and a lower surface 32 adapted to face one or more burners 16 of the associated stove 10. The top side of the griddle 20 includes upwardly extending side walls 36 that surround the perimeter of the upper cooking surface 30. The side walls 36 extend from the upper cooking surface 30 at an angle between, for example, 45-90 degrees from vertical. The griddle 20 includes front and rear handles 40 that extend outwardly from the upwardly extending side walls 36 located at the front and rear edges of the griddle body 21.

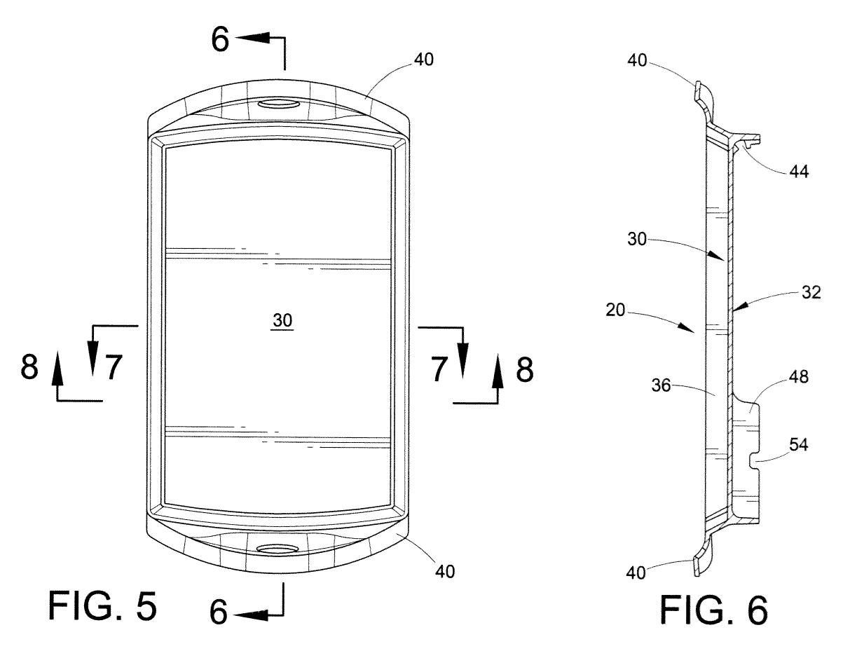

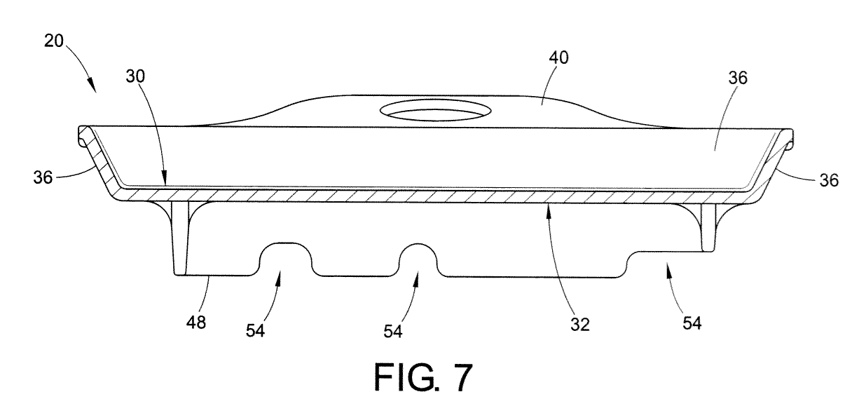

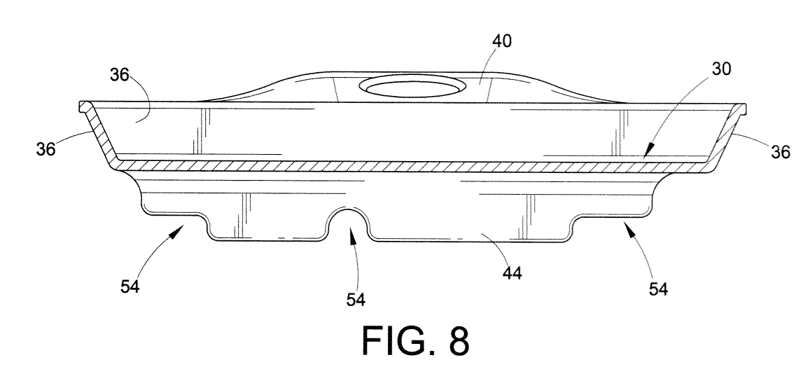

With reference to FIG. 4, and additional reference to FIGS. 5-8, the lower surface 32 of the griddle body includes a front flange 44 and a rear flange 48 extending downwardly therefrom. Front flange 44 extends generally across the front edge of the lower surface 32. Rear flange 48 extends across the rear edge of the lower surface 32 and along the left and right edges for at least a portion thereof. With reference to FIG. 4, it can be seen that the lower flange 48 extends further on the left side of lower surface 32 than on the right side of lower surface 32 as viewed in FIG. 4. Each of the front flange 44 and rear flange 48 include a plurality of recesses 54 adapted to receive respective fingers of a burner support, such as burner support 18. The recesses 54 are spaced apart along at least two sides of rear flange 48 such that when respective fingers 22 of the burner supports 18 are received in the recesses 54, the griddle 20 is restricted from lateral movement in the plane of the cooking surface. The recesses 54 can be generally semi-circular or may have any other shape desired for receiving a corresponding finger 22 of a burner support 18. Recesses 54 having a greater width are generally for receiving a finger 22 at an angle other than perpendicular to the respective flange in which the recess is formed.

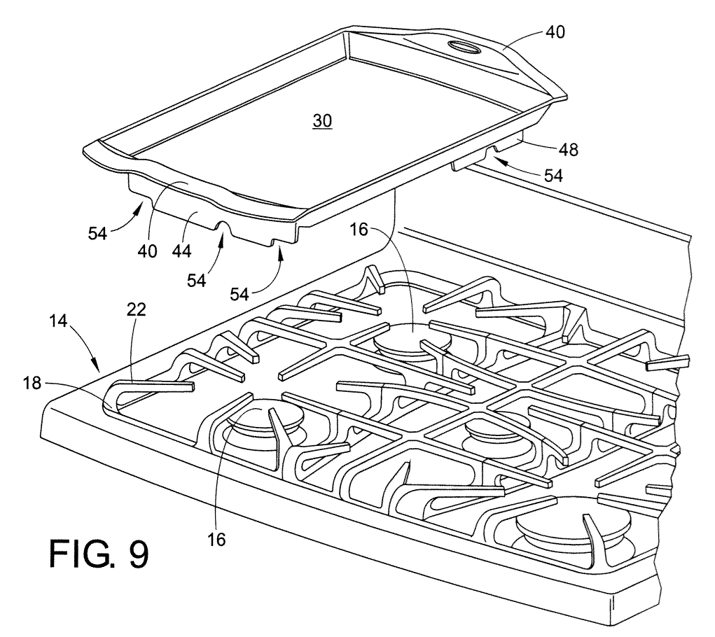

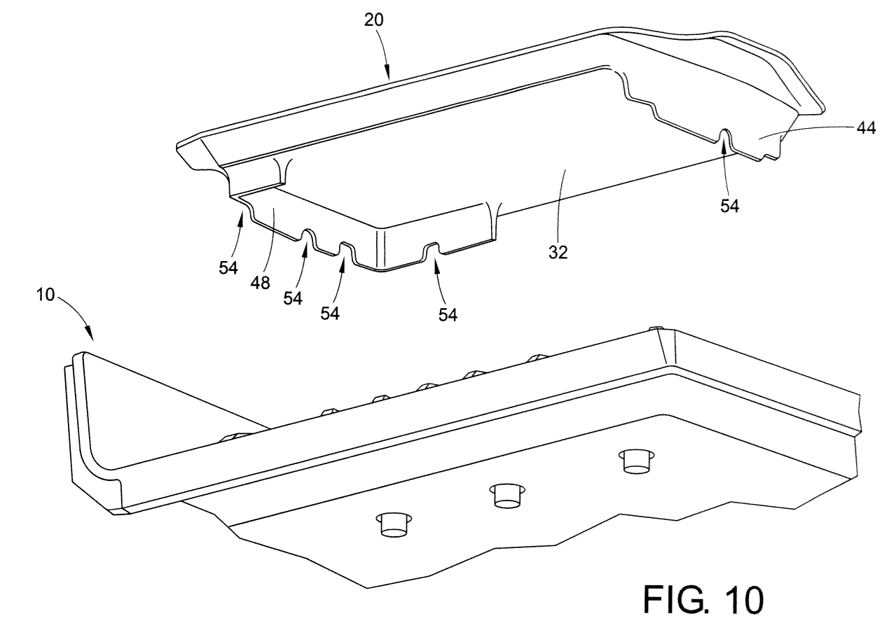

Turning now to FIG. 9, the griddle 20 is illustrated above stove 10 prior to being lowered onto the burner supports 18. Triangle indicators point to individual fingers 22 that will support the griddle 20 when it is placed on the burner supports 18. The triangle indicators also indicate positions whereat the recesses 54 engage the fingers 22 and thereby locate the griddle 20 relative to the burner support 18. With further reference to FIG. 10, the corresponding support locations of the griddle 20 are highlighted by triangular symbols. As will be appreciated, the support locations generally correspond to the recesses 54 in the front flange 44 and the rear flange 48.

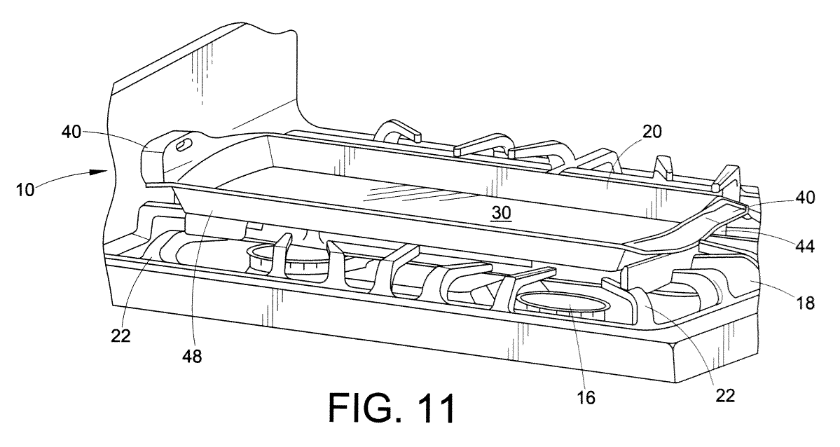

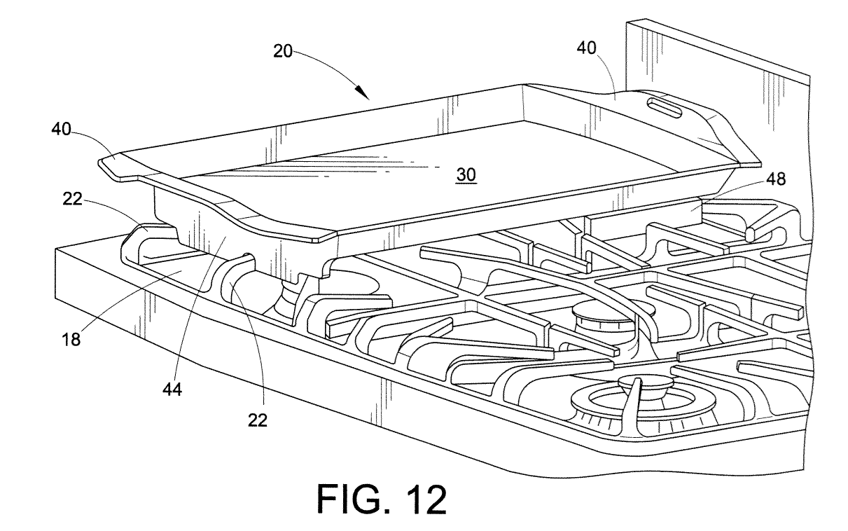

In FIGS. 11 and 12, the griddle 20 is shown installed on stove 10 with the recesses 54 in the respective front and rear flanges 44 and 48 receiving respective fingers 22 of the burner support 18. As will be appreciated, the recesses 54 in the front flange receive respective burner fingers 22 thereby locating the front portion of the griddle 20 relative to burner support 18 and restrict lateral movement of the front portion of the griddle 20.

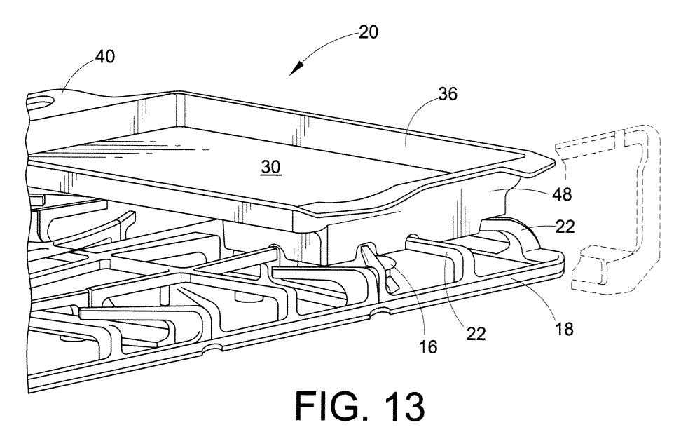

With continuing reference to FIG. 13, the rear flange 48 having recesses 54 in both the rear wall of the flange as well as a side wall of the flange is engaged with respective fingers 22 that restrict both back and forth and side to side movement of the griddle 20 relative to burner support 18.

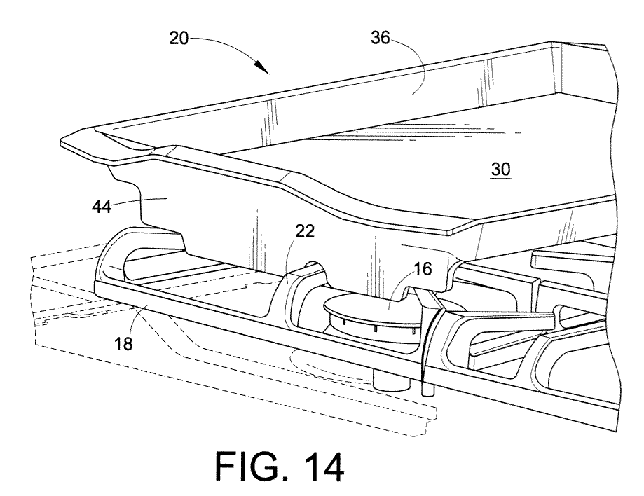

Both the front flange 44 and rear flange 48 have a vertical dimension that is chosen to locate the lower surface 32 of the griddle 20 a desired distance from the burners 16. The desired spacing between the lower surface 32 and the burners 16 may vary due to the size of the griddle and/or the heating capacity of the burner 16. In general, however, the flanges 44 and 48 will have a vertical dimension such that the lower surface 32 will be spaced apart from the burners 16 a distance between 0.5″ to 2.0″ and preferably approximately 1.25″. As seen in FIGS. 11-14, when supported on the burner support 18 the flanges of the griddle generally extend no further than the bottom surface of the fingers 22 thus avoiding or limiting effects on the flame characteristics of the burner.

As will be appreciated, the front flange 44 is generally continuous across the front edge of the grill 20. This serves to reflect and/or redirect heat generated by the burners 16 so as to reduce temperature adjacent the front side of the griddle 20 that could otherwise be projected towards a user. Similarly, the rear flange 48, being continuous across the backside of the griddle 20, reflects and/or redirects heat generated by the burner 16 towards the central portion of the griddle and away from the adjacent structure of the stove. The side portions of rear flange 48 also operate to reflect and/or redirect heat generated by the burners 16 toward central portions of the griddle 20.

As noted previously, one of the side portions of the rear flange 48 extends further along its respective side of the lower surface 32. By configuring the sides of the rear flange in such manner, heat generated by the burners 16 is redirected to a peripheral edge of the stove and away from an operator and/or adjacent stove components. As will be appreciated, other configurations of the flanges are possible for deflecting and or redirecting heat generated by associated burners, depending on the specific application.

As will now be appreciated, the present disclosure provides a large capacity griddle having a surface area greater than 150″ that can be used over one or more burners having a combined BTU per hour rating of 19,000. The griddle 20 includes front and rear flanges 44 and 48 that both locate the griddle relative to the burners and act to reflect and/or redirect heat generated by the burners so as to maintain a more uniformly heated griddle cooking surface as well as to avoid unacceptably high temperatures adjacent the griddle that may impact the stove structure and/or present a hazard to an operator.

The invention has been described with reference to the preferred embodiments. Obviously, modifications and alterations will occur to others upon reading and understanding the preceding detailed description. It is intended that the invention be construed as including all such modifications and alterations.

What is claimed is:

1. A large capacity removable griddle for use in conjunction with one or more burners of an associated stove, comprising:
a griddle body having an upper cooking surface and a to surface adapted to face one or more burners of the associated stove;
upwardly extending side walls surrounding at least a portion of the cooking surface;
at least one flange extending downwardly from the lower surface, said flange surrounding at least a portion of at least two sides of the lower surface;
wherein the flange includes a plurality of recesses for receiving respective fingers of a burner support of the associated stove, the plurality of recesses being spaced apart along at least two sides of the flange such that when respective fingers are received in said recesses, the griddle is restricted from lateral and transverse movement in the plane of the cooking surface; and
wherein the flange is adapted to channel heat towards a central portion of the griddle.

2. A large capacity removable griddle as set forth in claim 1, wherein the at least one flange includes both a front flange and a rear flange, each flange at least partially surrounding at least a portion of two sides of the burner, the front and rear flanges having a vertical dimension of between 0.5 and 2.0 inches for spacing the lower surface of the griddle body from the one or more burners of the associated stove.

3. A large capacity removable griddle as set forth in claim 2, further comprising at least one gap between the front and rear flanges for venting heat from a below the griddle body.

4. A large capacity removable griddle as set forth in claim 1, wherein the at least one flange and griddle body are a unitary structure.

5. A large capacity removable griddle as set forth in claim 4, wherein the at least one flange and griddle body are formed in a casting process.

6. A large capacity removable griddle as set forth on claim 5, wherein the at least one flange and griddle body are made of cast iron.

7. A large capacity removable griddle as set forth in claim 1, wherein at least one of the plurality of recesses in the at least one flange has a shape corresponding to a profile of a burner finger of the associated stove.

8. A large capacity removable griddle as set forth in claim 7, wherein the shape includes a semi-circular shape.

9. A large capacity removable griddle as set forth in claim 1, wherein the at least one flange comprises a rear flange extending along a back edge and at least a portion of two adjacent side edges of said lower surface.

10. A large capacity removable griddle as set forth in claim 9, wherein the rear flange extends along one side edge further than it extends along the other side edge.

11. A large capacity removable griddle as set forth in claim 9, further comprising a front flange extending along a front edge of said lower surface.

12. A large capacity removable griddle as set forth in claim 1, further comprising front and rear handles extending outwardly from the upwardly extending side walls located at front and rear edges of the griddle body.

13. A large capacity removable griddle as set forth in claim 12, wherein the front and rear handles are formed integrally with the griddle body and at least one flange.

14. A large capacity removable griddle as set forth in claim 1, wherein the side walls extend relative to the upper cooking surface at an angle between about 45 and 90 degrees from vertical.

15. A stove comprising at least one burner, a burner support including a plurality of support fingers surrounding said burner, and a large capacity removable griddle as set forth in claim 1 at least partially supported on said burner support.

16. A stove as set forth in claim 15, wherein the at least one burner has a rating of at least 19,000 BTU's.

17. A stove as set forth in claim 15, wherein the at least one flange of the griddle extends no lower than a bottom surface of at least one of the support fingers.

18. A stove as set forth in claim 17, wherein at least one recess in the flange has a depth approximately equivalent to a thickness of a corresponding support finger.
